(19) United States
(12) Patent Application Publication
(10) Pub. No.: US 2007/0224510 A1
(43) Pub. Date: Sep. 27, 2007

(54) ANODE AND BATTERY

(75) Inventors: Takeru Yamamoto, Fukushima (JP); Yosuke Ushio, Fukushima (JP); Takehiko Tanaka, Fukushima (JP); Tomitaro Hara, Fukushima (JP); Hiroyuki Akashi, Kanagawa (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/691,345

(22) Filed: Mar. 26, 2007

(30) Foreign Application Priority Data
Mar. 27, 2006 (JP) 2006-084485

(51) Int. Cl. H01M 4/62; H01M 10/40

(52) U.S. Cl. 429/232; 429/217; 429/316

(57) ABSTRACT

An anode and a battery capable of improving conductivity in spite of reducing the ratio of a binder are provided. A cathode and an anode face each other with a separator and an electrolyte in between. The anode includes an anode current collector and an anode active material layer arranged on the anode current collector. The anode active material layer includes an anode active material, a binder and a member including at least one kind selected from the group consisting of nickel, iron and a nickel compound or an iron compound. The content of the binder in the anode active material layer is within a range from 0.5 wt % to 5.0 wt %, both inclusive.

### CROSS REFERENCES TO RELATED APPLICATIONS

The present application relates to Japanese Patent Application JP 2006-084485 filed in the Japanese Patent Office on Mar. 27, 2006, the entire contents of which being incorporated herein by reference.

### BACKGROUND

The present invention relates to an anode including a binder and a battery using the anode.

In recent years, a large number of portable electronic devices such as camcorders, cellular phones and laptop computers have been emerged, and an attempt to reduce the size and the weight of them has been made. Accordingly, the development of batteries, specifically secondary batteries as portable power sources for the electronic devices has been actively promoted. Among them, a lithium-ion secondary battery receives attention, because a high energy density can be achieved.

In such a lithium-ion secondary battery, to increase the capacity, the filling amount of an active material is increased, but on the other hand, the ratio of an electrical conductor, a binder or the like is limited. However, when the ratio of the binder is reduced to further increase the capacity, the binding property declines with repeated cycles of charge and discharge, thereby the discharge capacity declines.

Therefore, it has been considered that a binder with a high molecular weight and high intrinsic viscosity is used to reduce the ratio of the binder, thereby the capacity is increased. However, for example, when vapor deposition graphite which is used in related arts is used as a binder, the electrical conductor and the binder are incorporated into each other, thereby dispersiveness declines. Therefore, the binder locally exists in an electrode, so the peel strength of the electrode declines, and the electrical conductor also locally exists in the electrode, so the electrical resistance increases, and the discharge capacity declines with repeated cycles of charge and discharge.

The use of metal nickel as an electrical conductor has been considered, and, for example, metal nickel is used in the cathode of a nickel hydrogen secondary battery or a nickel cadmium secondary battery (for example, refer to Japanese Unexamined Patent Application Publication Nos. H3-167762, H3-238772, H3-263769, H4-17264 and H7-190671).

On the other hand, also in a lithium-ion secondary battery, the use of metal nickel as an electrical conductor has been considered. For example, metal nickel is vapor deposited on a conductive substrate, or metal nickel is used with thermally decomposed graphite or graphite of which the crystal is oriented parallel to a current collector (for example, refer to Japanese Examined Patent Application Publication Nos. H7-56795, H7-118308 and H8-28238 and Japanese Patent No. 3157079).

However, metal nickel is used only under such specific conditions, and it is difficult to widely use metal nickel.

### SUMMARY

In view of the foregoing, it is desirable to provide an anode and a battery capable of improving conductivity in spite of reducing the ratio of a binder.

According to an embodiment, there is provided an anode including an anode current collector and an anode active material layer arranged on the anode current collector, wherein the anode active material layer includes an anode active material, a binder and a member including at least one kind selected from the group consisting of nickel (Ni), iron (Fe), a nickel compound and an iron compound, and the content of the binder in the anode active material layer is within a range from 0.5 wt % to 5.0 wt %, both inclusive.

According to an embodiment, there is provided a battery including a cathode, an anode and an electrolyte, wherein the anode includes an anode current collector and an anode active material layer arranged on the anode current collector, the anode active material layer includes an anode active material, a binder and a member including at least one kind selected from the group consisting of nickel, iron, a nickel compound and an iron compound, and the content of the binder in the anode active material layer is within a range from 0.5 wt % to 5.0 wt %, both inclusive.

In the anode and the battery according to an embodiment, the anode active material layer includes an anode active material, a binder and a member including at least one kind selected from the group consisting of nickel, iron, a nickel compound and an iron compound, so even if the content of the binder in the anode active material layer is within a range from 0.5 wt % to 5.0 wt %, both inclusive, a decline in conductivity with charge and discharge can be prevented. Therefore, battery characteristics such as capacity and cycle characteristics can be improved.

Moreover, when the member having a fibrous shape, a fiber diameter of 5 μm or less, and a ratio of the fiber length to the fiber diameter (fiber length/fiber diameter) of 5 or more is used, higher conductivity can be secured.

Further, even if the purity of nickel or iron in the member is 90 wt % or more, a higher conductive network in the anode active material layer can be secured.

Additional features and advantages are described herein, and will be apparent from, the following Detailed Description and the figures.

### BRIEF DESCRIPTION OF THE FIGURES

FIG. 1 is an exploded perspective view of a secondary battery according to an embodiment.

FIG. 2 is a sectional view of a spirally wound electrode body taken along a line II-II of FIG. 1.

### DETAILED DESCRIPTION

A preferred embodiment will be described in detail below referring to the accompanying drawings.

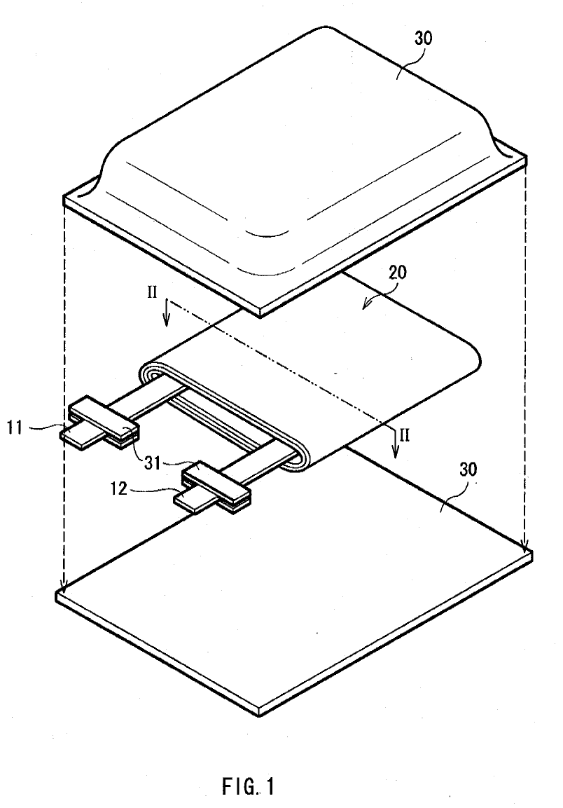

FIG. 1 shows the structure of a secondary battery according to an embodiment of the invention. The secondary battery uses lithium as an electrode reactant, and includes a spirally wound electrode body 20 to which a cathode terminal 11 and an anode terminal 12 are attached in film-shaped package members 30.

The cathode terminal 11 and the anode terminal 12 are drawn from the interiors of the package members 30 to outside, for example, in the same direction. The cathode terminal 11 and the anode terminal 12 are made of, for example, a metal material such as aluminum (Al), copper (Cu), nickel or stainless in a sheet shape or a mesh shape.

The package members 30 are made of, for example, a rectangular aluminum laminate film including a nylon film, aluminum foil and a polyethylene film which are bonded in this order. The package members 30 are disposed so that the polyethylene film of each of the package members 30 faces the spirally wound electrode body 20, and edge portions of the package members 30 are adhered to each other by fusion bonding or an adhesive. An adhesive film 31 is inserted between the package members 30, and the cathode terminal 11 and the anode terminal 12 for preventing the entry of outside air. The adhesive film 31 is made of, for example, a material having adhesion to the cathode terminal 11 and the anode terminal 12, for example, a polyolefin resin such as polyethylene, polypropylene, modified polyethylene or modified polypropylene.

In addition, the package members 30 may be made of another aluminum laminate film formed by sandwiching aluminum foil between other polymer films, a laminate film with any other structure, a polymer film such as polypropylene, or a metal film.

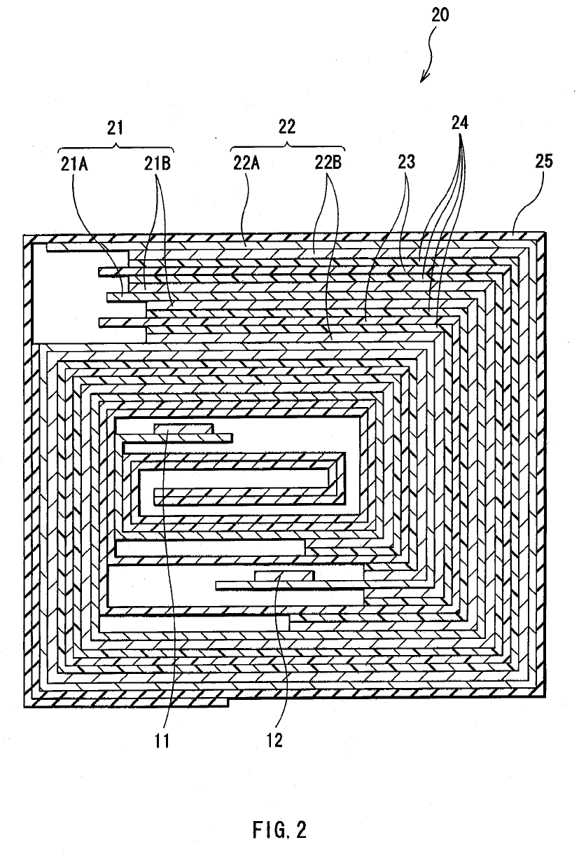

FIG. 2 shows a sectional view of the spirally wound electrode body 20 taken along a line II-II of FIG. 1. The spirally wound electrode body 20 is a spirally wound laminate including a pair of a cathode 21 and an anode 22 with a separator 23 and an electrolyte 24 in between, and an outermost portion of the spirally wound electrode body 20 is protected with a protective tape 25.

The cathode 21 includes, for example, a cathode current collector 21A having a pair of facing surfaces and a cathode active material layer 21B arranged on both sides of the cathode current collector 21A. The cathode current collector 21A has an exposed portion where the cathode active material layer 21B is not arranged in an end in a longitudinal direction, and the cathode terminal 11 is attached to the exposed portion. The cathode current collector 21A is made of, for example, metal foil such as aluminum foil, nickel foil or stainless foil. The cathode active material layer 21B includes one kind or two or more kinds of cathode materials capable of inserting and extracting lithium as cathode active materials, and if necessary, the cathode active material layer 21B may include an electrical conductor and a binder.

Examples of the cathode materials capable of inserting and extracting lithium include chalcogenide not including lithium such as titanium sulfide (TiS₂), molybdenum sulfide (MoS₂), niobium selenide (NbSe₂) or vanadium oxide (V₂O₅), a lithium complex oxide including lithium, a lithium-containing phosphate compound, and a polymer compound such as polyacetylene or polypyrrole.

Among them, a lithium complex oxide including lithium and a transition metal element, or a lithium-containing phosphate compound including lithium and a transition metal element is preferable, because a high voltage and a high energy density can be obtained, and a lithium complex oxide or a lithium-containing phosphate compound including at least one kind selected from the group consisting of cobalt (Co), nickel, manganese (Mn) and iron as a transition metal element is more preferable. The chemical formulas of the lithium complex oxide and the lithium-containing phosphate compound are represented by, for example, LiₓMIO₂ and LiYMIIPO₄, respectively. In the formulas, MI and MII each include one or more kinds of transition metal elements. The values of x and y depend on a charge-discharge state of the battery, and are generally within a range of 0.05≦x≦1.10 and 0.05≦y≦1.10, respectively.

Specific examples of the lithium complex oxide and the lithium-containing phosphate compound include lithium-cobalt complex oxide (LiₓCoO₂), lithium-nickel complex oxide (LiₓNiO₂), lithium-nickel-cobalt complex oxide (LiₓNi₁₋ₓCO_{z}O₂ (z<1)), lithium-manganese complex oxide (LiMn₂O₄) having a spinel structure, a lithium-iron phosphate compound (Li_{y}FePO₄) and a lithium-iron-manganese phosphate compound (Li_{y}Fe₁₋ᵥMnᵥPO₄ (v<1)).

Examples of the electrical conductor include carbon materials such as graphite, carbon black and ketjen black, and one kind or a mixture of two or more kinds selected from them is used. Moreover, in addition to carbon materials, a material having conductivity such as a metal material or a conductive polymer material may be used. Examples of the binder include synthetic rubber such as styrene butadiene rubber, fluorine-based rubber or ethylene propylene diene rubber, and a polymer material such as polyvinylidene fluoride, and one kind or a mixture of two or more kinds selected from them is used.

The anode 22 includes an anode current collector 22A having a pair of facing surfaces and an anode active material layer 22B arranged on both sides of the anode current collector 22A. The anode current collector 22A has an exposed portion where the anode active material layer 22B is not arranged in an end in the longitudinal direction, and the anode terminal 12 is attached to the exposed portion. The anode current collector 22A is made of, for example, metal foil such as copper foil, nickel foil or stainless foil.

The anode active material layer 22B includes an anode active material, a binder and a member including at least one kind selected from the group consisting of nickel, iron, a nickel compound and an iron compound, and the content of the binder in the anode active material layer 22B is within a range from 0.5 wt % to 5.0 wt %, both inclusive. In the case where nickel, iron, the nickel compound or the iron compound is included, even if the content of the binder is within a range from 0.5 wt % to 5.0 wt %, both inclusive, a decline in conductivity with charge and discharge can be prevented. Therefore, battery characteristics such as capacity or cycle characteristics can be improved.

Examples of the binder include polyvinylidene fluoride, styrene butadiene rubber, polyacrylonitrile, and mixtures thereof.

The purity of nickel or iron in the member is preferably 90 wt % or more, because a higher conductive network in the anode active material layer 22B can be secured.

Moreover, the member may have a fibrous shape, a spherical shape, or a flake shape; however, the fibrous shape is preferable, because higher conductivity can be secured. In the case where the member has a fibrous shape, it is preferable that the fiber diameter is 5 μm or less, and the ratio of the fiber length to the fiber diameter (fiber length/fiber diameter) is 5 or more, because still higher conductivity can be secured.

Examples of the anode active material include anode materials capable of inserting and extracting lithium, and one kind or two or more kinds selected from them are used.

Examples of the anode materials capable of inserting and extracting lithium include a carbon material, a material including a metal element or a metalloid element capable of forming an alloy with lithium as an element, a metal oxide and a polymer compound.

Among them, as the carbon material, mesocarbon microbead, artificial graphite such as bonded artificial graphite or natural graphite is used, and the carbon material may have a spherical shape or a grained flake shape.

Among them, a carbon material of which the crystal orientation is not parallel to the orientation of the anode current collector when the anode active material layer 22B is formed is preferable. It is because even if the volume density of the anode active material layer 22B is increased, the permeability for an electrolytic solution is increased, thereby lithium is easily inserted. More specifically, a carbon material in which when the anode 22 is analyzed by X-ray diffraction using a CuK α ray as an X ray, the ratio of the 002 (c-axis) diffraction peak intensity to the 110 (ab-plane) diffraction peak intensity (002 diffraction peak intensity/110 diffraction peak intensity) attributed to the carbon material is less than 10 is preferable, and a carbon material in which the ratio is 5 or less is more preferable.

The separator 23 is made of, for example, an insulating thin film having high ionic permeability and predetermined mechanical strength such as a porous film made of a polyolefin-based synthetic resin such as polypropylene or polyethylene, or a porous film made of an inorganic material such as nonwoven ceramic, and the separator 23 may have a structure in which two or more kinds of the porous films are laminated.

The electrolyte 24 is made of a so-called gel electrolyte in which a polymer compound holds an electrolytic solution. The separator 23 may be impregnated with the electrolyte 24, or the electrolyte 24 may exist between the separator 23, and the cathode 21 and the anode 22.

The electrolytic solution includes, for example, a solvent and an electrolyte salt dissolved in the solvent. Examples of the solvent include one or more of the following types of materials: lactone-based solvents such as γ-butyrolactone, γ-valerolactone, δ-valerolactone and ε-caprolactone, carbonate-based solvents such as ethylene carbonate, propylene carbonate, butylene carbonate, vinylene carbonate, dimethyl carbonate, ethyl methyl carbonate and diethyl carbonate, ether-based solvents such as 1,2-dimethoxyethane, 1-ethoxy-2-methoxyethane, 1,2-diethoxyethane, tetrahydrofuran and 2-methyltetrahydrofuran, nitrile-based solvents such as acetonitrile, sulfolane-based solvents, phosphoric acids, phosphate solvents, and nonaqueous solvents such as pyrrolidones.

As the electrolyte salt, any salt which is dissolved in the solvent and generates ions may be used, and one kind or a mixture of two or more kinds of salts may be used. For example, in the case where a lithium salt is used, as the lithium salt, lithium hexafluorophosphate (LiPF₆), lithium tetrafluoroborate (LiBF₄), lithium hexafluoroarsenate (LiAsF₆), lithium perchlorate (LiClO₄), lithium trifluoromethanesulfonate (LiCF₃SO₃), lithium bis(trifluoromethanesulfonyl)imide (LiN(SO₂CF₃)₂), lithium tris(trifluoromethanesulfonyl)methyl (LiC(SO₂CF₃)₃), lithium tetrachloroaluminate (LiAlCl₄), lithium hexafluorosilicate (LiSiF₆) or the like is used.

As the polymer compound, a polymer of vinylidene fluoride including a unit represented by Chemical Formula 1 such as polyvinylidene fluoride or a copolymer of vinylidene fluoride and hexafluoropropylene is preferable, because oxidation-reduction stability is high.

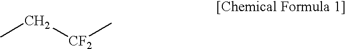

Moreover, as the polymer compound, a polymer compound formed by polymerizing a polymerizable compound is cited. Examples of the polymerizable compound include a polymerizable compound including a group in which a substituent group such as a methyl group is substituted for hydrogen in a vinyl group or a part of the vinyl group. More specifically, monofunctional acrylate such as acrylic ester, monofunctional methacrylate such as methacrylic ester, polyfunctional acrylate such as diacrylic ester or triacrylic ester, polyfunctional methacrylate such as dimethacrylic ester or trimethacrylic ester, acrylonitrile, methacrylonitrile and the like are cited, and among them, an ester including an acrylate group or a methacrylate group is preferable, because polymerization easily proceeds, and the reactivity of the polymerizable compound is high. Moreover, as the polymerizable compound, a polymerizable compound not including an ether group is preferable, because when an ether group is included in the polymerizable compound, lithium ions are coordinated in the ether group, thereby ionic conductivity declines. Examples of such a polymer compound include polyacrylic ester including a unit represented by Chemical Formula 2, polymethacrylic ester, polyacrylonitrile or polymethacrylonitrile.

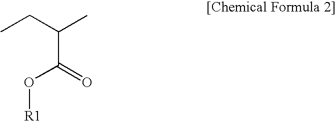

where R1 represents CⱼH₂ⱼ₋₁Oₖ, and j and k are integers of 1≦j≦8 and 0≦k≦4, respectively.

Only one kind selected from the polymerizable compounds may be used; however, a mixture of a monofunctional body and a polyfunctional body, only one polyfunctional body, or a mixture of two or more kinds of polyfunctional bodies is preferably used, because with such a structure, the mechanical strength and the electrolytic solution holding property of the polymer formed by polymerization easily become compatible.

Further, a polymer compound having a structure in which at least one kind selected from polyvinyl acetal and its derivatives is polymerized is preferable.

Polyvinyl acetal is a compound in which a repeating unit includes a unit including an acetal group represented by Chemical Formula 3(1), a unit including a hydroxyl group represented by Chemical Formula 3(2) and a unit including an acetyl group represented by Chemical Formula 3(3). Specific examples include polyvinyl formal in which R2 shown in Chemical Formula 3(1) represents hydrogen, and polyvinyl butyral in which R2 represents a propyl group.

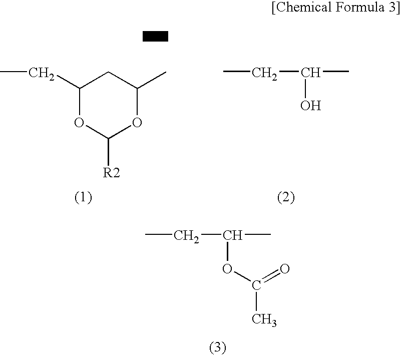

where R2 represents a hydrogen atom or an alkyl group having 1 to 3 carbon atoms.

The ratio of the acetal group in polyvinyl acetal is preferably within a range from 60 mol % to 80 mol %, both inclusive, because in the range, the solubility in a solvent can be improved, and the stability of the electrolyte can be further improved. Moreover, the weight-average molecular weight of polyvinyl acetal is preferably within a range from 10000 to 500000, both inclusive, because when the molecular weight is too low, it is difficult for a polymerization reaction to proceed, and when it is too high, the viscosity of the electrolytic solution is increased.

The polymer compound may be formed by polymerizing only polyvinyl acetal, only one kind selected from the derivatives of polyvinyl acetal, or two ore more kinds selected from polyvinyl acetal and its derivatives, or may be a copolymer of a monomer except for polyvinyl acetal and its derivatives. Further, the polymer compound may be formed by polymerization using a cross-linking agent.

As the electrolyte 24, the electrolytic solution may be used as-is as a liquid electrolyte without holding the electrolytic solution by a polymer compound. In this case, the separator 23 is impregnated with the electrolytic solution.

The open circuit voltage (that is, battery voltage) of the secondary battery in a fully charged state is not specifically limited, but is preferably designed within 4.10 V to 6.00 V, both inclusive, because a high capacity can be obtained. In the secondary battery, for example, even if the same cathode active material is used, the amount of extraction of lithium is increased with an increase in the open circuit voltage, so the anode 22 is designed to prevent extracted lithium from being precipitated.

The secondary battery can be manufactured by the following steps, for example.

At first, for example, the cathode active material, the binder and the electrical conductor are mixed to form a cathode mixture, and the cathode mixture is dispersed in a solvent such as N-methyl-2-pyrrolidone to form cathode mixture slurry. Next, the cathode mixture slurry is applied to both sides or one side of the cathode current collector 21A, and was dried and compression molded to form the cathode active material layer 21B, thereby the cathode 21 is formed. Next, for example, the cathode terminal 11 is bonded to the cathode current collector 21A by, for example, ultrasonic welding or spot welding. After that, a precursor solution including the electrolytic solution, the polymer compound and a mixed solvent is prepared, and the precursor solution is applied to the cathode active material layer 21B, that is, both sides or one side of the cathode 21, and the mixed solvent is volatilized to form the electrolyte 24.

Moreover, for example, the anode active material, the binder and a member including at least one kind selected from the group consisting of nickel, iron, a nickel compound and an iron compound are mixed to form an anode mixture, and the anode mixture is dispersed in a solvent such as N-methyl-2-pyrrolidone to form anode mixture slurry. Next, the anode mixture slurry is applied to both sides or one side of the anode current collector 22A, and was dried and compression molded to form the anode active material layer 22B, thereby the anode 22 is formed. Next, the anode terminal 12 is bonded to the anode current collector 22A by, for example, ultrasonic welding or spot welding, and the electrolyte 24 is formed on the anode active material layer 22B, that is, both sides or one side of the anode 22 as in the case of the cathode 21.

After that, the cathode 21 on which the electrolyte 24 is formed and the anode 22 on which the electrolyte 24 is formed are laminated with the separator 23 in between to form a laminate, and the laminate is spirally wound, and then the protective tape 25 is bonded to an outermost portion of the laminate so as to form the spirally wound electrode body 20. Finally, the spirally wound electrode body 20 is sandwiched between the package members 30, and edge portions of the package members 30 are adhered to each other by thermal fusion bonding or the like to seal the spirally wound electrode body 20 in the package members 30. At this time, the adhesive film 31 is inserted between the cathode terminal 11 and the anode terminal 12, and the package members 30. Thereby, the secondary battery shown in FIGS. 1 and 2 is completed.

Moreover, the secondary battery may be manufactured by the following steps. At first, as described above, the cathode 21 and the anode 22 are formed, and the cathode terminal 11 and the anode terminal 12 are attached to the cathode 21 and the anode 22, respectively. Then, the cathode 21 and the anode 22 are laminated with the separator 23 in between to form a laminate, and the laminate is spirally wound. The protective tape 25 is bonded to an outermost portion of the spirally wound laminate so as to form a spirally wound body as a precursor body of the spirally wound electrode body 20. Next, the spirally wound body is sandwiched between the package members 30, and the edge portions of the package members 30 except for one side are adhered by thermal fusion bonding to form a pouched package, thereby the spirally wound body is contained in the package members 30. Electrolytic compositions which include the electrolytic solution, monomers as materials of a polymer compound and, if necessary, any other material such as a polymerization initiator or a polymerization inhibitor are prepared, and are injected into the package members 30.

After the electrolytic compositions are injected, an opened portion of the package members 30 is sealed by thermal fusion bonding in a vacuum atmosphere. Next, the monomers are polymerized by applying heat to form the polymer compound, thereby the gel electrolyte 24 is formed so as to assemble the secondary battery shown in FIGS. 1 and 2.

Further, when the electrolytic solution is used as the electrolyte 24, after a spirally wound body is formed as described above, and is sandwiched between the package members 30, the electrolytic solution is injected, and then the package members 30 are sealed.

When the secondary battery is charged, for example, lithium ions are extracted from the cathode 21, and are inserted into the anode 22 through the electrolyte 24. On the other hand, when the secondary battery is discharged, for example, lithium ions are extracted from the anode 22, and are inserted into the cathode 21 through the electrolyte 24. In this case, the anode active material layer 22B includes the binder and the member including at least one kind selected from the group consisting of nickel, iron, a nickel compound and an iron compound, and the content of the binder in the anode active material layer 22B is within a range from 0.5 wt % to 5.0 wt %, both inclusive, so a decline in conductivity with charge and discharge can be prevented, and a high capacity can be obtained.

Thus, according to an embodiment, the anode active material layer 22B includes the anode active material, the binder and the member including at least one kind selected from the group consisting of nickel, iron, a nickel compound and an iron compound, so even if the content of the binder in the anode active material layer 22B is within a range from 0.5 wt % to 5.0 wt %, both inclusive, a decline in conductivity with charge and discharge can be prevented. Therefore, battery characteristics such as capacity and cycle characteristics can be improved.

Moreover, when a member having a fibrous shape, a fiber diameter of 5 μm or less, and a ratio of the fiber length to the fiber diameter (fiber length/fiber diameter) of 5 or more is used as the member, higher conductivity can be secured.

Further, even if the purity of nickel or iron in the member is 90 wt % or more, a higher conductive network in the anode active material layer 22B can be secured.

Specific examples will be described in detail below according to various embodiments.

### EXAMPLES 1-1 TO 1-3

At first, 0.5 mol of lithium carbonate and 1 mol of cobalt carbonate were mixed to form a mixture, and the mixture was fired at 900° C. for 5 hours in air to synthesize lithium-cobalt complex oxide (LiCoO₂) as a cathode active material. Next, 85 wt % of lithium-cobalt complex oxide powder, 5 wt % of artificial graphite as an electrical conductor and 10 wt % of polyvinylidene fluoride as a binder were mixed to form a cathode mixture, and the cathode mixture was dispersed in N-methyl-2-pyrrolidone as a solvent to form cathode mixture slurry. Next, after the cathode mixture slurry was applied to both sides of the cathode current collector 21A made of aluminum foil with a thickness of 20 μm, and was dried, the cathode mixture slurry was compression molded to form the cathode active material layer 21B, thereby the cathode 21 was formed. After that, the cathode terminal 11 was attached to the cathode 21.

Moreover, spherical mesocarbon microbead (MCMB) which was a carbon material as an anode active material, polyvinylidene fluoride (PVdF) as a binder and fibrous metal nickel as a member were mixed to form an anode mixture. At that time, the ratio (weight ratio) of mesocarbon microbead:polyvinylidene fluoride:metal nickel was 94.5:0.5:5 in Example 1-1, 91.5:3.5:5 in Example 1-2 and 90:5:5 in Example 1-3. Moreover, as the metal nickel, metal nickel having a fibrous shape, a fiber diameter of 2.5 μm, a ratio of the fiber length to the fiber diameter (fiber length/fiber diameter)(hereinafter referred to as aspect ratio) of 20, and a purity of nickel of 99 wt % was used. Further, as the mesocarbon microbead, a mixture of mesocarbon microbead with a particle diameter of 12 μm and mesocarbon microbead with a particle diameter of 30 μm was used. Next, the anode mixture was dispersed in N-methyl-2-pyrrolidone as a solvent to form anode mixture slurry, and after the anode mixture slurry was applied to both sides of the anode current collector 22A made of rolled copper foil and was dried, the anode mixture slurry was compression molded to form the anode active material layer 22B, thereby the anode 22 was formed. At that time, the filling amounts of the cathode active material and the anode active material were adjusted so that the open circuit voltage in a fully charged state was designed to be 4.2 V. Moreover, the formed anode 22 was analyzed by X-ray diffraction using a CuKα ray as an X ray. As a result, the ratio of the 002 diffraction peak intensity to the 110 diffraction peak intensity attributed to the carbon material was less than 3. After that, the anode terminal 12 was attached to the anode 22.

Next, an electrolyte solution was formed by dissolving 1 mol of lithium hexafluorophosphate in a solvent formed by mixing ethylene carbonate and diethyl carbonate at a weight ratio of 3:7.

Next, the obtained electrolytic solution was held by a copolymer of hexafluoropropylene and vinylidene fluoride as a polymer compound to form the gel electrolyte 24 on each of the cathode 21 and the anode 22. The ratio of hexafluoropropylene in the copolymer was 6.9 wt %.

After that, the cathode 21 on which the electrolyte 24 was formed and the anode 22 on which the electrolyte 24 was formed were laminated and spirally wound with the separator 23 made of a polyethylene film with a thickness of 9 μm to form the spirally wound electrode body 20.

The obtained spirally wound electrode body 20 was sandwiched between the package members 30 made of a laminate film, and was sealed under a reduced pressure to form the secondary battery shown in FIGS. 1 and 2.

As Comparative Examples 1-1 and 1-2 relative to Examples 1-1 through 1-3, anodes were formed as in the case of Examples 1-1 through 1-3, except that the content of polyvinylidene fluoride in the anode active material layer was 0 wt % or 5.1 wt %, more specifically an anode mixture in which the ratio (weight ratio) of mesocarbon microbead:polyvinylidene fluoride:metal nickel was 95:0:5 in Comparative Example 1-1 and 89.9:5.1:5 in Comparative Example 1-2 was used, and secondary batteries were formed. Moreover, when the formed anodes were analyzed by X-ray diffraction using a CuKα ray as an X ray, the ratio of the 002 diffraction peak intensity to the 110 diffraction peak intensity attributed to the carbon material was less than 3.

The rated energy density, the cycle characteristics and the load characteristics of each of the secondary batteries of Examples 1-1 through 1-3 and Comparative Examples 1-1 and 1-2 were determined by the following steps.

As a charge-discharge cycle, at first, at 23° C., the secondary battery was charged at a constant current of 1 C and a constant voltage until reaching an upper limit voltage of 4.2 V for 15 hours, and then the secondary battery was discharged at a constant current of 1 C until reaching an end voltage of 2.5 V. The charge-discharge cycle was repeated, and the rated energy density was determined from the discharge capacity in the first cycle. Moreover, the cycle characteristics were determined as the discharge capacity retention ratio in the 500th cycle to the discharge capacity in the first cycle, that is, (discharge capacity in the 500th cycle/the discharge capacity in the first cycle)×100 (%). The results are shown in Table 1. In addition, 1 C represents a current value at which the theoretical capacity of a battery can be discharged for 1 hour.

Moreover, at 23° C., the secondary battery was charged at a constant current of 1 C and a constant voltage until reaching an upper limit voltage of 4.2 V for 15 hours, and then the secondary battery was discharged at a constant current of 1 C until reaching an end voltage of 2.5 V, thereby the discharge capacity at 1 C was determined. Further, after the secondary battery was charged at a constant current and a constant voltage under the same conditions, the secondary battery was discharged at a constant current of 3 C until reaching an end voltage of 2.5 V, thereby the discharge capacity at 3 C was determined. The load characteristics was determined as the ratio of the discharge capacity at 3 C to the discharge capacity at 1 C, that is, (discharge capacity at 3 C/discharge capacity at 1 C)×100 (%). The results are shown in Table 1. In addition 3 C represents a current value at which the theoretical capacity of a battery can be discharged for ⅓ hours.

TABLE 1

| | | | | | | | | RATED | CYCLE | |
|---|---|---|---|---|---|---|---|---|---|---|
| | BINDER | | | | | FIBER | | ENERGY | CHARAC- | LOAD |
| | | WT | | PURITY | MEMBER | DIAMETER | ASPECT | DENSITY | TERISTICS | CHARACTERISTICS |
| | KIND | % | MATERIAL | (WT %) | SHAPE | (μm) | RATIO | (Wh) | (%) | (%) |
| EXAMPLE 1-1 | PVdF | 0.5 | Ni | 99 | FIBROUS | 2.5 | 20 | 488 | 81 | 96 |
| EXAMPLE 1-2 | PVdF | 3.5 | Ni | 99 | FIBROUS | 2.5 | 20 | 488 | 82 | 96 |
| EXAMPLE 1-3 | PVdF | 5 | Ni | 99 | FIBROUS | 2.5 | 20 | 488 | 81 | 96 |
| COMPARATIVE | — | 0 | Ni | 99 | FIBROUS | 2.5 | 20 | 485 | 27 | 96 |
| EXAMPLE 1-1 | | | | | | | | | | |
| COMPARATIVE | PVdF | 5.1 | Ni | 99 | FIBROUS | 2.5 | 20 | 484 | 32 | 96 |
| EXAMPLE 1-2 | | | | | | | | | | |

As shown in Table 1, in Examples 1-1 through 1-3 in which the content of the binder in the anode active material layer 22B was within a range from 0.5 wt % to 5 wt %, both inclusive, compared to Comparative Examples 1-1 and 1-2 in which the content of the binder was out of the range, the rated energy density and the cycle characteristics were improved.

In other words, it was found out that when the anode active material layer 22B included nickel, and the content of the binder in the anode active material layer 22B was within a range from 0.5 wt % to 5.0 wt %, both inclusive, the capacity and the cycle characteristics could be improved.

### EXAMPLES 2-1 TO 2-14

The anodes 22 were formed as in the case of Example 1-2, except that members each having a material, purity, a shape, a fiber diameter (or a particle diameter or the like) and an aspect ratio shown in Table 2 were used, and secondary batteries were formed.

Moreover, as Comparative Example 2-1 relative to Examples 2-1 through 2-14, an anode was formed as in the case of Example 1-1, except that the member was not used, and a secondary battery was formed. An anode mixture with a ratio (weight ratio) of mesocarbon microbead:polyvinylidene fluoride of 96.5:4.5 was used.

Moreover, as Comparative Examples 2-2 through 2-7, anodes were formed as in the case of Examples 2-1 through 2-14, except that metal except for nickel, iron, a nickel compound and an iron compound was used as the member, and secondary batteries were formed. The material, the purity, the fiber diameter (or the particle diameter or the like) and the aspect ratio of each member are as shown in Table 2. Moreover, in Table 2, spherical (spike) means a state in which a string of fibers form a spherical shape. Further, as the aspect ratio of Example 2-2 and Comparative Example 2-2, the aspect ratio between the fiber diameter and the fiber length in the anode 22 was observed by an optical electron microscope, and the aspect ratio was determined by the average of 10 fibers.

When the anodes 22 were analyzed by X-ray diffraction as in the case of Examples 1-1 through 1-3, the ratio of the 002 diffraction peak intensity to the 110 diffraction peak intensity attributed to the carbon material was less than 3.

The rated energy density, the cycle characteristics and the load characteristics of each of the secondary batteries of Examples 2-1 through 2-14 and Comparative Examples 2-1 through 2-7 were determined as in the case of Examples 1-1 through 1-3. The results are shown in Table 2.

TABLE 2

| | | | | | | | | RATED | CYCLE | LOAD |
|---|---|---|---|---|---|---|---|---|---|---|
| | | | | | | FIBER | | ENERGY | CHARAC- | CHARAC- |
| | BINDER | | MATE- | PURITY | MEMBER | DIAMETER | ASPECT | DENSITY | TERISTICS | TERISTICS |
| | KIND | WT % | RIAL | (WT %) | SHAPE | (μm) | RATIO | (Wh) | (%) | (%) |
| EXAMPLE 2-1 | PVdF | 3.5 | NiO | 99 | SPHERICAL | 1 um | <2 | 488 | 72 | 96 |
| | | | | | | DIAMETER 20 um | | | | |
| EXAMPLE 2-2 | PVdF | 3.5 | Fe | 90 | FLAKE | THICKNESS | 7 | 488 | 71 | 96 |
| | | | | | | 0.4–1 um | | | | |
| EXAMPLE 2-3 | PVdF | 3.5 | Fe | 90 | FIBROUS | 2 | 5 | 488 | 74 | 96 |
| EXAMPLE 2-4 | PVdF | 3.5 | STAIN- | — | FIBROUS | 2 | 5 | 488 | 77 | 96 |
| | | | LESS | | | | | | | |
| EXAMPLE 2-5 | PVdF | 3.5 | Ni | 89 | FIBROUS | 2 | 5 | 488 | 77 | 96 |
| EXAMPLE 2-6 | PVdF | 3.5 | Ni | 91 | FIBROUS | 2.5 | 20 | 488 | 80 | 96 |
| EXAMPLE 1-2 | PVdF | 3.5 | Ni | 99 | FIBROUS | 2.5 | 20 | 488 | 82 | 96 |
| EXAMPLE 2-7 | PVdF | 3.5 | Ni | 99 | SPHERICAL | 5 | <2 | 488 | 77 | 96 |
| | | | | | (SPIKE) | | | | | |
| EXAMPLE 2-8 | PVdF | 3.5 | Ni | 99 | SPHERICAL | 10 (PARTICLE | <2 | 488 | 76 | 96 |
| | | | | | | DIAMETER) | | | | |
| EXAMPLE 2-9 | PVdF | 3.5 | Ni | 99 | FLAKE | 20 (PARTICLE | 7 | 488 | 74 | 96 |
| | | | | | | DIAMETER) | | | | |
| EXAMPLE 2-10 | PVdF | 3.5 | Ni | 99 | FIBROUS | 0.1 | 4 | 488 | 81 | 96 |
| EXAMPLE 2-11 | PVdF | 3.5 | Ni | 99 | FIBROUS | 0.2 | 6 | 488 | 84 | 96 |
| EXAMPLE 2-12 | PVdF | 3.5 | Ni | 99 | FIBROUS | 1 | 15 | 488 | 83 | 96 |
| EXAMPLE 2-13 | PVdF | 3.5 | Ni | 99 | FIBROUS | 2.5 | 20 | 488 | 83 | 96 |
| EXAMPLE 2-14 | PVdF | 3.5 | Ni | 99 | FIBROUS | 4 | 10 | 488 | 83 | 96 |
| COMPARATIVE | PVdF | 3.5 | — | — | — | — | — | 487 | 25 | 96 |
| EXAMPLE 2-1 | | | | | | DIAMETER 20 um | | | | |
| COMPARATIVE | PVdF | 3.5 | Zn | 90 | FLAKE | THICKNESS | 7 | 487 | 31 | 96 |
| EXAMPLE 2-2 | | | | | | 0.4–1 um | | | | |
| | | | | | | 1–5 um | | | | |
| COMPARATIVE | PVdF | 3.5 | Cu | 99 | SPHERICAL | (PARTICLE | <2 | 487 | 25 | 96 |
| EXAMPLE 2-3 | | | | | | DIAMETER) | | | | |
| | | | | | | 1–5 um | | | | |
| COMPARATIVE | PVdF | 3.5 | Al | 99 | SPHERICAL | (PARTICLE | <2 | 487 | 24 | 96 |
| EXAMPLE 2-4 | | | | | | DIAMETER) | | | | |
| | | | | | | 1–5 um | | | | |
| COMPARATIVE | PVdF | 3.5 | Mn | 95 | SPHERICAL | (PARTICLE | <2 | 487 | 31 | 96 |
| EXAMPLE 2-5 | | | | | | DIAMETER) | | | | |
| | | | | | | 1–5 um | | | | |
| COMPARATIVE | PVdF | 3.5 | Mg | 95 | SPHERICAL | (PARTICLE | <2 | 487 | 30 | 96 |
| EXAMPLE 2-7 | | | | | | DIAMETER) | | | | |

As shown in Table 2, even if iron, a nickel compound or an iron compound was used as the member, the cycle characteristics could be improved as in the case of Example 1-2.

Moreover, it was obvious from Examples 1-2, 2-5 and 2-6 in which the purity of nickel was changed that the cycle characteristics were improved with an increase in purity.

Further, in Examples 2-11 through 2-14 in which as the member, metal nickel having a fibrous shape, a fiber diameter of 5 μm or less and an aspect ratio of 5 or more was used, compared to Example 2-10 in which the aspect ratio was less than 5, the cycle characteristics were improved.

In other words, it was found out that when the anode active material layer 22B included a member including at least one kind selected from nickel, iron, a nickel compound and an iron compound, and the content of the binder in the anode active material layer 22B was within a range from 0.5 wt % to 5.0 wt %, both inclusive, the capacity and the cycle characteristics could be improved.

Moreover, it was found out that a member having a fibrous shape, a fiber diameter of 5 μm or less and a ratio of the fiber length to the fiber diameter (fiber length/fiber diameter) of 5 or more was preferably used.

Further, it was found out that the purity of nickel or iron in the member was preferably 90 wt % or more.

### EXAMPLES 3-1 TO 3-3

The anodes 22 were formed as in the case of Example 1-2, except that instead of polyvinylidene fluoride, styrene butadiene rubber (SBR) was used as a binder, and instead of mesocarbon microbead, flake-grained natural graphite, flake-grained bonded artificial graphite or flake-grained graphite covered with a polymer compound was used, and secondary batteries were formed. The flake-grained natural graphite had a particle diameter of 20 μm to 40 μm, and the flake-grained bonded artificial graphite had an average particle diameter of 35 μm, and flake-grained graphite covered with the polymer compound had a particle diameter of 20 μm to 40 μm, and the polymer was polyuronide.

As Comparative Examples 3-1 through 3-3 relative to Examples 3-1 through 3-3, anodes were formed as in the case of Examples 3-1 through 3-3, except that the member was not used, and secondary batteries were formed. More specifically, an anode mixture with a ratio (weight ratio) of the anode active material:styrene butadiene rubber of 96.5:3.5 was used.

When the anodes 22 were analyzed by X-ray diffraction as in the case of Examples 1-1 through 1-3, the ratio of the 002 diffraction peak intensity to the 110 diffraction peak intensity attributed to the carbon material was determined. The results are shown in Table 3.

Moreover, the rated energy density, the cycle characteristics and the load characteristics of each of the secondary batteries of Examples 3-1 through 3-3 and Comparative Examples 3-1 through 3-3 were determined as in the case of Examples 1-1 through 1-3. The results are shown in Table 3.

TABLE 3
Binder; styrene butadiene rubber 3.5 wt %

| | | ANODE ACTIVE MATERIAL | | | RATED | | |
|---|---|---|---|---|---|---|---|
| | | | | ORIEN- | ENERGY | CYCLE | LOAD |
| | | | | TATION | DENSITY | CHARACTERISTICS | CHARACTERISTICS |
| | MEMBER | KIND | SHAPE | (002)/(110) | (Wh) | (%) | (%) |
| EXMAPLE 3-1 | Ni | NATURAL | GRAINED | 4.5 | 490 | 82 | 96 |
| | | GRAPHITE | FLAKE | | | | |
| | | BONDED | | | | | |
| EXAMPLE 3-2 | Ni | ARTIFICIAL | GRAINED | 4 | 492 | 82 | 96 |
| | | GRAPHITE | FLAKE | | | | |
| EXAMPLE 3-3 | Ni | POLYMER- | GRAINED | 4 | 490 | 82 | 96 |
| | | COVERED | FLAKE | | | | |
| | | GRAPHITE | | | | | |
| COMPARATIVE | — | NATURAL | GRAINED | 4.5 | 470 | 26 | 96 |
| EXAMPLE 3-1 | | GRAPHITE | FLAKE | | | | |
| | | BONDED | | | | | |
| COMPARATIVE | — | ARTIFICIAL | GRAINED | 4 | 481 | 29 | 96 |
| EXAMPLE 3-2 | | GRAPHITE | FLAKE | | | | |
| COMPARATIVE | — | POLYMER- | GRAINED | 4 | 475 | 28 | 96 |
| EXAMPLE 3-3 | | COVERED | FLAKE | | | | |
| | | GRAPHITE | | | | | |

As shown in Table 3, the same results as those in Example 1-2 were obtained. In other words, it was found out that even in the case where another anode active material was used, when the anode active material layer 22B included a member including at least one kind selected from the group consisting of nickel, iron, a nickel compound and an iron compound, and the content of the binder in the anode active material layer 22B was within a range from 0.5 wt % to 5.0 wt %, both inclusive, the capacity and the cycle characteristics could be improved.

### EXAMPLES 4-1 TO 4-4

The anodes 22 were formed as in the case of Example 1-2, except that the content of metal nickel as the member in the anode active material layer 22B was changed within a range from 2 wt % to 30 wt %, and secondary batteries were formed. More specifically, an anode mixture with a ratio (weight ratio) of mesocarbon microbead:polyvinylidene fluoride:metal nickel of 94.5:3.5:2, 86.5:3.5:10, 76.5:3.5:20 or 66.5:3.5:30 was used.

When the anodes 22 were analyzed by X-ray diffraction as in the case of Examples 1-1 through 1-3, the ratio of the 002 diffraction peak intensity to the 110 diffraction peak intensity attributed to the carbon material was less than 3.

The rated energy density, the cycle characteristics and the load characteristics of each of the secondary batteries of Examples 4-1 through 4-4 were determined as in the case of Examples 1-1 through 1-3. The results are shown in Table 4.

TABLE 4
Binder; polyvinylidene fluoride 3.5 wt %

| | | | MEMBER | | | | RATED | | |
|---|---|---|---|---|---|---|---|---|---|
| | | | | FIBER | | | ENERGY | CYCLE | LOAD |
| | MATE- | PURITY | | DIAMETER | ASPECT | CONTENT | DENSITY | CHARACTERISTICS | CHARACTERISTICS |
| | RIAL | (WT %) | SHAPE | (μm) | RATIO | (WT %) | (Wh) | (%) | (%) |
| EXAMPLE 4-1 | Ni | 99 | FIBROUS | 2.5 | 20 | 2 | 488 | 81 | 96 |
| EXAMPLE 1-2 | Ni | 99 | FIBROUS | 2.5 | 20 | 5 | 488 | 82 | 96 |
| EXAMPLE 4-2 | Ni | 99 | FIBROUS | 2.5 | 20 | 10 | 486 | 83 | 96 |
| EXAMPLE 4-3 | Ni | 99 | FIBROUS | 2.5 | 20 | 20 | 479 | 84 | 96 |
| EXAMPLE 4-4 | Ni | 99 | FIBROUS | 2.5 | 20 | 30 | 466 | 85 | 96 |

As shown in Table 4, as the content of metal nickel increased, the cycle characteristics were improved, and the rated energy density declined.

In other words, it was found out that the content of the member including at least one kind selected from the group consisting of nickel, iron a nickel compound and an iron compound in the anode active material layer 22B was preferably within a range from 2 wt % to 30 wt %, both inclusive.

### EXAMPLES 5-1 TO 5-6

Secondary batteries were formed as in the case of Example 1-2, except that the filling amounts of the cathode active material and the anode active material were adjusted so that the open circuit voltage (that is, battery voltage) in a fully charged state was designed to be 4.3 V in Example 5-1, 4.5 V in Example 5-2, 4.1 V in Example 5-3, 4.2 V in Example 5-4, 4.3 V in Example 5-5 and 4.5 V in Example 5-6. At that time, in Examples 5-3 through 5-6, instead of the gel electrolyte 24, an electrolytic solution was used, and as the separator 23, instead of a polyethylene (PE) film with a thickness of 9 μm, a polyethylene (PE) film with a thickness of 15 μm was used in Example 5-3, and a film with a thickness of 15 μm formed by laminating polypropylene (PP), polyethylene (PE) and polypropylene (PP) in this order was used in Examples 5-4 through 5-6. Moreover, in Example 5-3, as the binder, instead of polyvinylidene fluoride, polyacrylonitrile (PAN) was used. In addition, the content of the binder in the anode active material layer 22B was 3.5 wt %, and the content of metal nickel was 10 wt % in Examples 5-1 and 5-2, and 15 wt % in Examples 5-3 through 5-6.

As Comparative Examples 5-1 through 5-6 relative to Examples 5-1 through 5-6, anodes were formed as in the case of Examples 5-1 through 5-6, except that metal nickel was not used, and secondary batteries were formed.

When the anodes 22 were analyzed by X-ray diffraction as in the case of Examples 1-1 through 1-3, the ratio of the 002 diffraction peak intensity to the 110 diffraction peak intensity attributed to the carbon material was less than 3.

The rated energy density, the cycle characteristics and the load characteristics of each of the secondary batteries of Examples 5-1 through 5-6 and Comparative Examples 5-1 through 5-6 were determined as in the case of Examples 1-1 through 1-3. At that time, the upper limit charge voltage was as shown in Table 5. The results are shown in Table 5.

TABLE 5

| | | | | UPPER | | | | | |
|---|---|---|---|---|---|---|---|---|---|
| | | | | LIMIT | | | RATED | CYCLE | LOAD |
| | MEMBER | | | CHARGE | | | ENERGY | CHARAC- | CHARAC- |
| | MATE- | CONTENT | BIND- | VOLTAGE | SEP- | ELEC- | DENSITY | TERISTICS | TERISTICS |
| | RIAL | (WT %) | ER | (V) | ARATOR | TROLYTE | (Wh) | (%) | (%) |
| EXAMPLE 5-1 | Ni | 10 | PVdF | 4.3 | PE | GEL | 512 | 84 | 96 |
| EXAMPLE 5-2 | Ni | 10 | PVdF | 4.5 | PE | GEL | 529 | 82 | 96 |
| EXAMPLE 5-3 | Ni | 15 | PAN | 4.1 | PE | LIQUID | 571 | 83 | 96 |
| EXAMPLE 5-4 | Ni | 15 | PVdF | 4.2 | PP/PE/PP | LIQUID | 581 | 83 | 96 |
| EXAMPLE 5-5 | Ni | 15 | PVdF | 4.3 | PP/PE/PP | LIQUID | 610 | 82 | 96 |
| EXAMPLE 5-6 | Ni | 15 | PVdF | 4.5 | PP/PE/PP | LIQUID | 622 | 80 | 96 |
| COMPARATIVE | — | | PVdF | 4.3 | PE | GEL | 498 | 32 | 96 |
| EXAMPLE 5-1 | | | | | | | | | |
| COMPARATIVE | — | | PVdF | 4.5 | PE | GEL | 511 | 29 | 96 |
| EXAMPLE 5-2 | | | | | | | | | |
| COMPARATIVE | — | | PAN | 4.1 | PE | LIQUID | 571 | 41 | 96 |
| EXAMPLE 5-3 | | | | | | | | | |
| COMPARATIVE | — | | PVdF | 4.2 | PP/PE/PP | LIQUID | 581 | 36 | 96 |
| EXAMPLE 5-4 | | | | | | | | | |
| COMPARATIVE | — | | PVdF | 4.3 | PP/PE/PP | LIQUID | 502 | 38 | 96 |
| EXAMPLE 5-5 | | | | | | | | | |
| COMPARATIVE | — | | PVdF | 4.5 | PP/PE/PP | LIQUID | 513 | 35 | 96 |
| EXAMPLE 5-6 | | | | | | | | | |

As shown in Table 5, the same results as those of Example 1-2 were obtained. In other words, it was found out that even in the case of a secondary battery with another shape, when the anode active material layer 22B included a member including at least one kind selected from the group consisting of nickel, iron, a nickel compound and an iron compound, the cycle characteristics could be improved.

### EXAMPLES 6-1, 6-2

Secondary batteries were formed as in the case of Example 1-2, except that the method of forming the electrolyte 24 or the structure of the electrolyte 24 was changed.

More specifically, in Example 6-1, polyvinylidene fluoride was applied to the surface of the separator 23, and a spirally wound body was formed and contained in the package members 30, and then the electrolytic solution was injected into the package members 30 to form the electrolyte 24. The composition of the electrolytic solution was the same as that of Example 1-2.

In Example 6-2, after polyvinyl formal and the electrolytic solution were mixed, and injected into the package members 30, and then polyvinyl formal was polymerized to form the electrolyte 24. The composition of the electrolytic solution was the same as that of Example 1-2.

As Comparative Examples 6-1 and 6-2 relative to Examples 6-1 and 6-2, anodes were formed as in the case of Examples 6-1 and 6-2, except that metal nickel was not used as the member, and secondary batteries were formed.

The rated energy density, the cycle characteristics and the load characteristics of each of the secondary batteries of Examples 6-1 and 6-2 and Comparative Examples 6-1 and 6-2 were determined as in the case of Examples 1-1 through 1-3. The results are shown in Table 6.

TABLE 6
Binder; polyvinylidene fluoride 3.5 wt %

| | | | | | | | RATED | CYCLE | LOAD |
|---|---|---|---|---|---|---|---|---|---|
| | | | | FIBER | | | ENERGY | CHARAC- | CHARAC- |
| | MATE- | PURITY | MEMBER | DIAMETER | ASPECT | POLYMER | DENSITY | TERISTICS | TERISTICS |
| | RIAL | (Wt %) | SHAPE | (μm) | RATIO | COMPOUND | (Wh) | (%) | (%) |
| EXAMPLE 1-2 | Ni | 99 | FIBROUS | 2.5 | 20 | PVdF | 488 | 82 | 96 |
| | | | | | | (ELECTRODE) | | | |
| EXAMPLE 6-1 | Ni | 99 | FIBROUS | 2.5 | 20 | PVdF | 492 | 84 | 96 |
| | | | | | | (SEPARATOR) | | | |
| EXAMPLE 6-2 | Ni | 99 | FIBROUS | 2.5 | 20 | POLYMER OF | 491 | 84 | 96 |
| | | | | | | POLYVINYL | | | |
| | | | | | | FORMAL | | | |
| COMPARATIVE | — | — | — | — | — | PVdF | 487 | 25 | 96 |
| EXAMPLE 2-1 | | | | | | (ELECTRODE) | | | |
| COMPARATIVE | — | — | — | — | — | PVdF | 492 | 39 | 96 |
| EXAMPLE 6-1 | | | | | | (SEPARATOR) | | | |
| COMPARATIVE | — | — | — | — | — | POLYMER OF | 491 | 32 | 96 |
| | | | | | | POLYVINYL | | | |
| EXAMPLE 6-2 | | | | | | FORMAL | | | |

As shown in Table 6, the same results as those of Example 1-2 were obtained. In other words, it was found out that even in the case where another electrolyte was used, when the anode active material layer 22B included a member including at least one kind selected from the group consisting of nickel, iron, a nickel compound and an iron compound, the cycle characteristics could be improved.

### EXAMPLE 7-1

The anode 22 was formed as in the case of Example 5-4, except that two kinds of metal nickel having the purity, the shape, the fiber diameter and the aspect ratio shown in Table 7 were mixed, and a secondary battery was formed.

When the anode 22 was analyzed by X-ray diffraction as in the case of Examples 1-1 through 1-3, the ratio of the 002 diffraction peak intensity to the 110 diffraction peak intensity attributed to the carbon material was less than 3.

The rated energy density, the cycle characteristics and the load characteristics of the secondary battery of Example 7-1 were determined as in the case of Examples 1-1 through 1-3. The results are shown in Table 7.

TABLE 7
Binder; polyvinylidene fluoride 3.5 wt %

| | | | MEMBER | | | | RATED | CYCLE | LOAD |
|---|---|---|---|---|---|---|---|---|---|
| | | | | FIBER | | | ENERGY | CHARAC- | CHARAC- |
| | MATE- | PURITY | | DIAMETER | ASPECT | CONTENT | DENSITY | TERISTICS | TERISTICS |
| | RIAL | (Wt %) | SHAPE | (μm) | RATIO | (Wt %) | (Wh) | (%) | (%) |
| EXAMPLE 5-4 | Ni | 99 | FIBROUS | 2.5 | 20 | 15 | 581 | 83 | 96 |
| EXAMPLE 7-1 | Ni | 99 | FIBROUS | 2.5 | 20 | 12 | 581 | 86 | 96 |
| | Ni | 99 | FIBROUS | 0.1 | 5 | 3 | | | |

As shown in Table 7, the same results as those of Example 5-4 were obtained. In other words, it was found out that when the anode active material layer 22B included a member including at least one kind selected from the group consisting of nickel, iron, a nickel compound and an iron compound, the cycle characteristics could be improved.

Although the present invention is described referring to the embodiment and the examples, the invention is not limited to the embodiment and the examples, and can be variously modified. For example, in the embodiment and the examples, the case where the electrolytic solution is used as the electrolyte and the case where the gel electrolyte in which a polymer compound holds the electrolytic solution is used are described; however, any other electrolyte may be used. Examples of the electrolyte include an organic solid electrolyte formed by dissolving or dispersing an electrolyte salt in a polymer compound having ionic conductivity, an inorganic solid electrolyte including an inorganic ionic conducting material such as ionic conducting ceramic, ionic conducting glass or ionic crystal, or a mixture of any of them and the electrolytic solution.

Moreover, in the embodiment and the examples, the case where a spirally wound electrode body formed by spirally winding the cathode 21 and the anode 22 is included in the package members 30 is described; however, a laminate including one layer or a plurality of layers of cathode 21 and one layer or a plurality of layers of anode 22 may be included.

Further, in the embodiment and the examples, the battery using lithium as an electrode reactant is described; however, the invention is applicable to the case where any other alkali metal such as sodium (Na) or potassium (K), alkali earth metal such as magnesium (Mg) or calcium (Ca) or any other light metal such as aluminum is used. In addition, the invention is applicable to not only secondary batteries but also other batteries such as primary batteries in the same manner.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An anode comprising:
an anode current collector and an anode active material layer arranged on the anode current collector,
wherein the anode active material layer includes an anode active material, a binder and a member including at least one member selected from the group consisting of nickel, iron, a nickel compound and an iron compound, and
the content of the binder in the anode active material layer ranges from 0.5 wt % to 5.0 wt %, both inclusive.

2. The anode according to claim 1, wherein
a purity of nickel or iron in the member is 90 wt % or more.

3. The anode according to claim 1, wherein
the binder includes at least one material selected from the group consisting of polyvinylidene fluoride, styrene butadiene rubber and polyacrylonitrile.

4. The anode according to claim 1, wherein
the member has a fibrous shape, and the fiber diameter is 5 μm or less, and the ratio of the fiber length to the fiber diameter (fiber length/fiber diameter) is 5 or more.

5. The anode according to claim 1, wherein
the anode active material includes an anode material capable of inserting and extracting lithium.

6. A battery comprising:
a cathode, an anode and an electrolyte,
wherein the anode includes an anode current collector and an anode active material layer arranged on the anode current collector,
the anode active material layer includes an anode active material, a binder and a member including at least one member selected from the group consisting of nickel, iron, a nickel compound and an iron compound, and
the content of the binder in the anode active material layer is ranges from 0.5 wt % to 5.0 wt %, both inclusive.

7. The battery according to claim 6, wherein
a purity of nickel or iron in the material is 90 wt % or more.

8. The battery according to claim 6, wherein
the binder includes at least one material selected from the group consisting of polyvinylidene fluoride, styrene butadiene rubber and polyacrylonitrile.

9. The battery according to claim 6, wherein
the material has a fibrous shape, and the fiber diameter is 5 μm or less, and the ratio of the fiber length to the fiber diameter (fiber length/fiber diameter) is 5 or more.

10. The battery according to claim 6, wherein
the anode active material includes a material capable of inserting and extracting lithium.

11. The battery according to claim 6, wherein
the electrolyte includes an electrolytic solution and a polymer including vinylidene fluoride as a component.

12. The battery according to claim 6, wherein
the electrolyte includes an electrolytic solution and a polymer having a structure in which at least one material selected from the group consisting of polyvinyl acetal and polymerized derivatives thereof.

13. The battery according to claim 6, wherein
the cathode, the anode and the electrolyte are contained in a film-shaped package member.

14. The battery according to claim 6, wherein
the open circuit voltage in a fully charged state per a pair of the cathode and the anode is ranges from 4.10 V to 6.00 V, both inclusive.
